(19) United States
(12) Patent Application Publication
(10) Pub. No.: US 2007/0130694 A1
(43) Pub. Date: Jun. 14, 2007

(54) Textile surface modification composition

(76) Inventors: Emily W. Michaels, Greenville, SC (US); Dominick J. Valenti, Greenville, SC (US); Eduardo Torres, Boiling Springs, SC (US); Diana C. Balasca, Simpsonville, SC (US)

Correspondence Address: Cheryl J. Brickey;Milliken & Company, Legal Department,, M-495, P.O. Box 1926, Spartanburg, SC, 29304, US

(21) Appl. No.: 11/599,737

(22) Filed: Nov. 15, 2006

Related U.S. Application Data
(60) Provisional application No. 60/749,387, filed on Dec. 12, 2005.

(51) Int. Cl. C11D 3/00

(52) U.S. Cl. 8/115.51; 510/515

(57) ABSTRACT

The invention relates to a textile surface modification composition comprising a fabric conditioner and cubic or layered (platelet) particles having a negative zeta potential, wherein the cubic or layered particles are selected from the group consisting of zeolites, aluminas, and silicas.

### CROSS-REFERENCE TO RELATED PATENT APPLICATIONS

This application claims priority to U.S. Provisional Application 60/749,387 and is hereby incorporated by reference.

### TECHNICAL FIELD

The present invention generally relates to a textile surface modification composition. More particularly, the invention relates to a compositions applied to fabrics with a fabric conditioner.

### BACKGROUND

Inert particles are known to aid in stain removal and have typically been used in carpets and automobile upholstery to impart anti-soil properties to these materials. There are also examples where the inert particles themselves are used as the cleaning agents. These materials have been used in conjunction with fluoropolymers to achieve stain resistance with oil/water repellency.

In laundry applications, zeolites are generally used as detergency builders due to their ability to remove calcium and magnesium compounds from the wash water which attributes to water hardness. Zeolites have also been used as carriers for surfactants, perfumes, and softening agents in detergent formulations because they allow the detergent to maintain it's free-flowing characteristics. Clays have also been incorporated in both detergent and fabric softening compositions in order to impart softness, as well as, improved stain removal.

### BRIEF DESCRIPTION OF THE DRAWINGS

An embodiment of the present invention will now be described by way of example, with reference to the accompanying drawings.

FIG. 1 is a an SEM image at 5,000× magnification of Zeolite A on 100% cotton fabric;

FIG. 2 is a an SEM image at 5,000× magnification of Zeolite A on 100% cotton fabric;

FIG. 3 is a an SEM image at 5,000× magnification of milled Zeolite A on 100% cotton fabric;

FIG. 4 is a an SEM image at 5,000× magnification of milled Zeolite A on 100% cotton fabric;

FIG. 5 is a an SEM image at 3,000× magnification of Alumina C on 100% cotton fabric;

FIG. 6 is a an SEM image at 3,000× magnification of Alumina C on 100% cotton fabric;

FIG. 7 is a an SEM image at 8,500× magnification of AlphaSan®, a known antimicrobial agent on 100% cotton fabric;

FIG. 8 is a an SEM image at 10,000× magnification of AlphaSan®, a known antimicrobial agent on 100% cotton fabric;

FIG. 9 is a an SEM image at 10,000× magnification of AlphaSan®, a known antimicrobial agent on 100% cotton fabric;

### SUMMARY OF THE INVENTION

This invention is the modification textile surface to dramatically improve the rate and degree of stain removal in subsequent laundry cleaning. This is accomplished by the addition of particles of appropriate amount, size, shape, and zeta potential to a mixture of water and textiles (for example wash or rinse cycle). The particles must have the appropriate electrostatic charge and morphology so that they exhaust onto the fabric and provide soil release. Another critical aspect of this invention is the ability of the particles to impart stain release properties, and/or tactile changes, without hurting the aesthetic quality or hand of the textiles.

The present invention provides advantages and/or alternatives over the prior art by providing a textile surface modification composition, also referred to as a soil release fabric conditioner, comprising a fabric conditioner and either cubic or layered (platelet) particles having a negative zeta potential.

### DETAILED DESCRIPTION OF THE INVENTION

The invention combines fabric conditioner, or other rinse treatments/aids, (often sold as “fabric softener” to the consumer) with either cubic or layered (platelet) particles having a negative zeta potential. As defined for this invention, “fabric conditioner” encompasses fabric conditioner and other rinse treatments and aids. The addition of either cubic or layered (platelet) particles with a negative zeta potential to the wash cycle (preferably to the rinse cycle) improves the soil release properties of stains on various textiles. The modification of textiles by this procedure can also improve abrasion durability, and hand modification to the fabric. The inert particles are exhausted onto the textile, rather than being padded on or having to pre-treat the material, and remain on the fabric through drying to enhance the performance of the fabric. This eliminates the need for a curing step at elevated temperatures or a cross-linking agent compared to other release agents that require a curing step.

It has been demonstrated that the combination of these inert particles, preferably inorganic, with fluoropolymer additives or other soil release polymers can further enhance the soil release performance of both of these additives, as well as, impart a non-durable water/oil repellency to the textile.

The modification of the properties of textile is not permanent and is maintained or removed at the inclusion or elimination of the particle addition in subsequent laundry cycles. The improved soil release property is accomplished with little or no negative impact on the aesthetic value or feel of the textile.

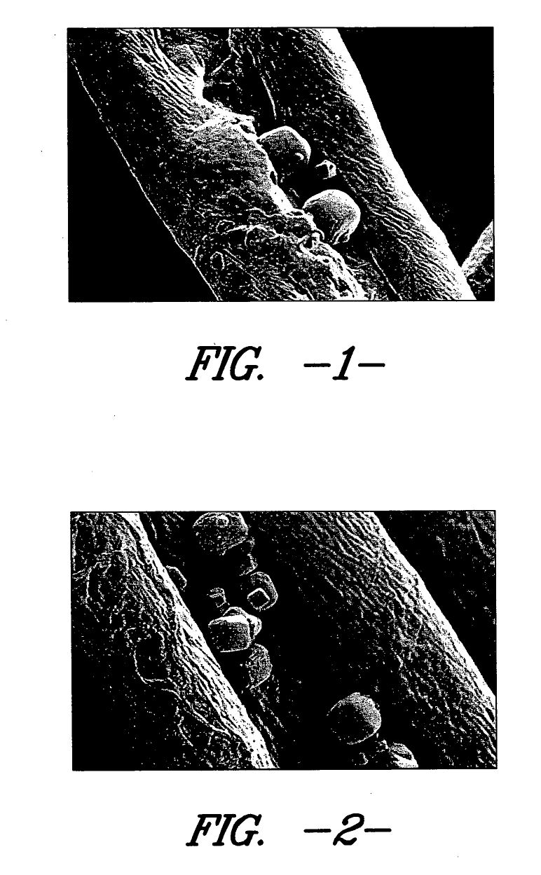

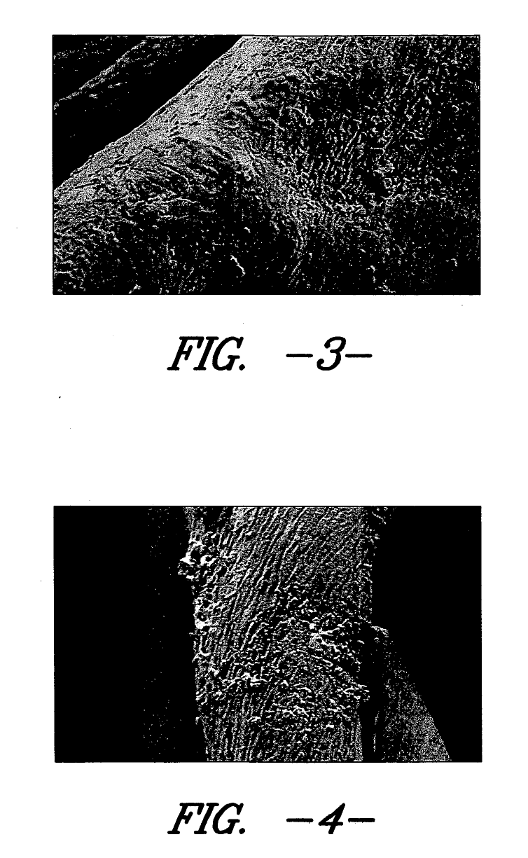

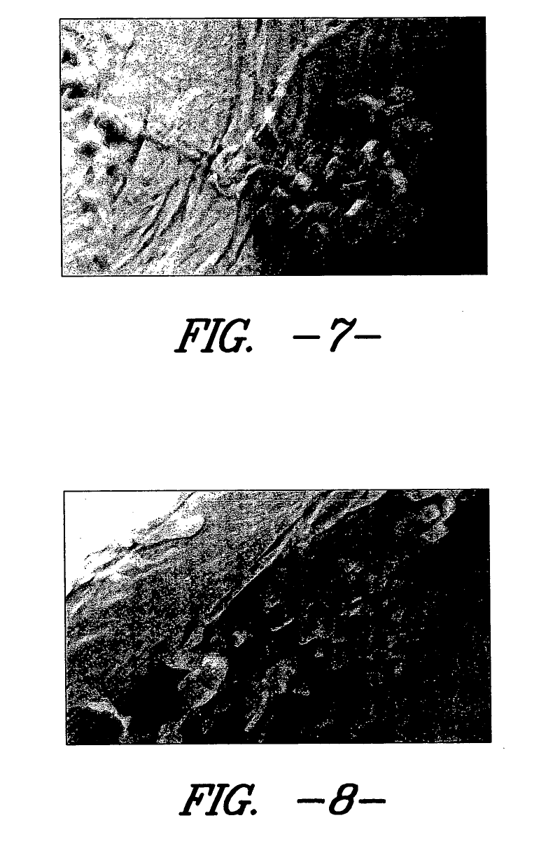

The cubic or layered (platelet) particles are selected from zeolites, aluminas, and silicas including surface modified versions of these particles. Surface modification can include, but is not limited to, hydrophobic, hydrophilic and hydrogen bonded coatings. The inert particles can include, but are not limited to: Zeolite A (Zeolite Na-A, 4A), Beta-Zeolite, NaY Zeolite, and various, other ion-exchange particles, alumina (colloidal, hydrated, and anhydrous), and silica (colloidal, hydrated, and anhydrous). Preferred is zeolite Na-A available commercially as Valfor® 100 Zeolite, a sodium aluminosilicate hydrated type Na A zeolite powder. Preferred is zeolite MAP (zeolite P having a silicon to aluminum ratio not exceeding 1.33) available commercially as Doucil™ A24 from Crosfield Chemicals. Alternatively, zeolite 4A available, for example, from Degussa AG as Wessalith™ P, is suitable for use in the compositions of the present invention. FIGS. 1 and 2 show SEM images at 5,000× magnification of Zeolite A on 100% cotton fabric. FIGS. 5 and 6 show SEM images at 3,000× magnification of Alumina C on 100% cotton fabric.

The cubic or layered particles preferably have an average particle size range of between 0.01 and 25 microns preferably between 0.1 and 15 micrometers, and preferably between 0.2 μm and 10 μm, and more preferably between 3 and 10 micrometers. It has been found that these particles size ranges produce excellent soil release properties on treated fabrics and stable formulations when added to the typical fabric conditioner chemistries.

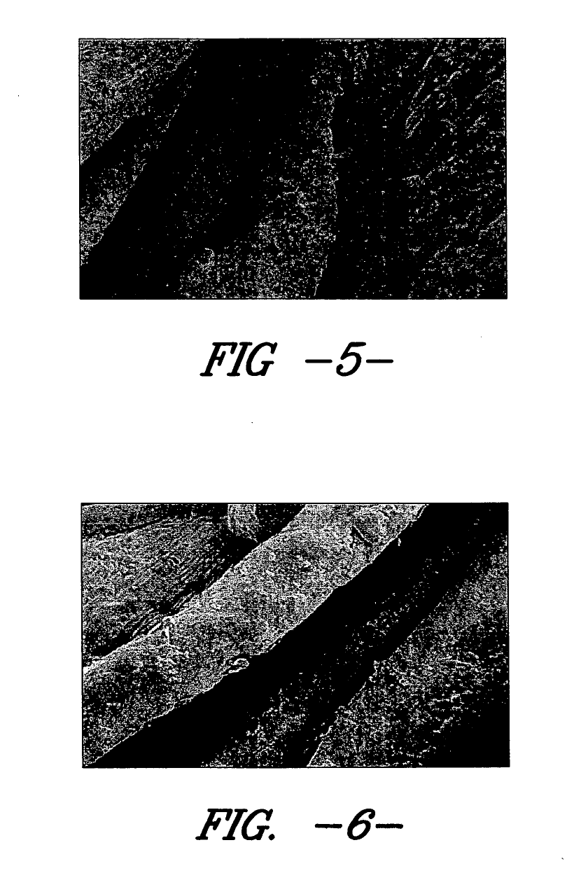

In some cases, the initial particle sizes of the cubic or layered (platelet) particles are larger than the preferred range and are preferably milled (size reduction by mechanical means) into the preferred size ranges. An example of a surface modified particle is Aerosil® R972 from Degussa which is a hydrophobic fumed silica produced through the chemical treatment of hydrophilic grades of silica with silanes or siloxanes. Mineral and Pigment Solutions, Inc. also offers surface treatments for particles. A further example of surface modification is coating the particles with silica. FIGS. 3 and 4 show SEM images at 5,000× magnification of milled Zeolite A on 100% cotton fabric.

Particle size reduction of amorphous and crystalline solids using wet milling techniques such as ball milling or media milling processes is a common technique used in the paint and pigment industry. Milling can take place in any suitable milling mill, including an airjet mill, a roller mill, a ball mill, a media mill, an attritor mill, a vibratory mill, a planetary mill, a sand mill, and a bead mill.

There are many different types of materials which may be used as milling media, such as glasses, ceramics, metals, and plastics. In a preferred embodiment, the grinding media comprise spherical yttria stabilized zirconia particles. The preferred proportions of the milling media, the solvent and optional dispersing agent can vary within wide limits and depend, for example, upon the particular material selected and the size and density of the milling media, etc.

Inorganic particles when dispersed in a liquid medium assume a charge. The zeta potential of a material is the measurement of the electrical voltage difference between the surface of the particle and the suspending liquid and, as such, can be used to predict the stability of colloidal suspensions. A suspension is more likely to be stable when the zeta potential is high due to the repulsion between the particles. The zeta potential of a particle can be altered through the addition of surfactants and the valence and concentration of ions in the suspension. The addition of particles with a negative zeta potential to the fabric conditioner allows these particles to deposit onto the surface of the fabric during the rinse cycle. Deposition onto the surface of the fabric is a result of the synergy between the fabric conditioner and the particles. The fabric conditioner not only serves as a carrier for the particles, but converts the zeta potential of the particles from negative to positive enabling them to deposit on the negatively charged surface of the fabric. Outside the presence of the fabric conditioner, these negatively charged particles serve to repel soils since most soils have negative zeta potentials as well. The deposited particles can also function in an adsorptive and ablative fashion.

Zeta potential has typically been measured by electrophoresis where electrodes are inserted into a suspension and a DC voltage applied. The charged particles are attracted to the electrode with the opposite charge. This motion is measured directly and is called electrophoretic mobility (EM). Electrophoretic mobility is expressed by two terms: velocity (microns/second) and electric field strength (volts/centimeter). Zeta potential is calculated from the measured electrophoretic mobility using a theoretical relation between the two that is dependant upon the dielectric constant and the viscosity of the suspending liquid. The resultant zeta potential is expressed in millivolts.

Two commercial systems available for the measurement of zeta potential are the AcoustoSizer by Dynamic Colloids and the Zeta-Meter by Zeta-Meter, Inc. The AcoustoSizer allows for the measurement of zeta potential in high solids suspensions by utilizing sound wave generation. According to Dynamic Colloids, the suspension is held in a cube-shaped cell containing a stirrer, pH probe and conductivity meter. A short pulse of alternating voltage is applied via the electrodes on opposing sides of the cell which cause the particles to vibrate back and forth as they are alternately attracted and repelled according to the changing polarity of the electrodes. A sound wave, called the electrokinetic sonic amplitude (ESA), is generated, measured and converted to zeta potential.

The Zeta-Meter measures the mobility of charged particles by timing the rate of their movement in a DC voltage field. According to Zeta-Meter, Inc., the suspension to be tested is first placed in an electrophoresis cell and electrodes placed on either end which are connected to a power unit. The cell is then placed on a mirrored cell holder, which directs the light beam from the illuminators upward, through the cell tube, allowing the particles to be viewed, after properly focusing and positioning the cell, the particles are tracked by applying the DC voltage and timed as they traverse one grid division. Zeta potential is then calculated from this data.

In laundry applications, zeolites are generally used as detergency builders due to their ability to remove calcium and magnesium compounds from the wash water which attributes to water hardness. However, the exchange rate with magnesium ions is slow so “co-builders” are typically used (such as STPP, carbonate and silicates). Zeolites have also been used as carriers for surfactants, perfumes, and softening agents in detergent formulations because they allow the detergent to maintain it's free-flowing characteristics.

The use of zeolites in the fabric conditioner also serves to remove calcium ions from the rinse water, as well as, allowing these materials to deposit onto the fabric. The exhaustion of these materials onto the surface of the fabric provides two mechanisms to help reduce staining of the fabric. The negative zeta potential of the zeolite helps to repel negatively charged soils thus reducing redeposition and subsequent staining. Also, the zeolites behave as temporary soil sites so that when soil comes into contact with the fabric (in non-aqueous conditions) the zeolites aid in the absorption of the stain. The zeolites, being a non-durbale treatment, are then removed in the next laundering along with the soil (ablative).

Zeolites have been shown to be less effective in short wash cycles (such as would occur when they are introduced in the rinse cycle). Zeolites are also typically used with “cobuilders” due to their slower exchange rate of magnesium ions.

Preferably, the textile surface modification composition is between 5 and 80 percent by weight cubic or layered (platelet) particles. In another embodiment, the surface modification composition is between 1 and 80 percent, more preferably 10 and 40 percent by weight cubic or layered (platelet) particles. The cubic or layered (platelet) particles are preferable at 0.25-4% by weight of fabric. In another embodiment, the cubic or layered (platelet) particles are 0.012-4%, more preferably 0.5 and 2% by weight of fabric. It has been found that these ranges produce excellent soil release characteristics.

It has long been recognized that certain chemical compounds have the capability of imparting softness to textile fabrics. These compounds, which are known generally as “softening agents”, “fabric softeners”, or “softeners”, have been used both by the textile industry and by home and industrial laundry processors to soften finished fabrics, thereby making them smooth, pliable and fluffy to handle. In addition to the quality of softness, the fabrics have a reduced tendency to static cling and are easier to iron.

The fabric conditioner in the textile surface modification composition may be any known fabric conditioning chemistry. The large majority of home laundering agents available on the market today under the name of softeners are compositions based on quaternary ammonium salts containing two long-chain alkyl groups within the molecule, such as di-hydrogenated tallow-alkyl dimethylammonium chloride, for instance. This is because quaternary ammonium salts produce satisfactory softening effects on various fibers even when used in small quantities.

In other fabric conditioning compositions, non-ester-linked quaternary ammonium fabric softening agents have been used although there is a trend away from such compounds to ester-linked quaternary ammonium fabric softening agents. It is desirable to use ester-linked compounds due to their inherent biodegradability. Such ester-linked quaternary ammonium compounds contain hydrocarbyl chains which can be unsaturated, partially hardened or fully saturated.

The combination of a fabric conditioner and the cubic or layered (platelet) particles during the laundry rinse cycle (via fabric softener etc.) enhances the soil release properties, fabric feel, and abrasion durability to the textile without adversely affecting the aesthetic value or hand of the textile.

Additional chemistries that can add stain release properties include flurorochemicals and other soil release polymers. When the layered particulates are combined with a fluorochemical treatment it further enhances the stain release properties, as well as imparting water and oil repellency to the textiles. Other classes of soil release polymers which can be used consist of, but are not limited to, carboxyl group polymers including: acrylic, methacrylic and maleic acid polymers, hydroxyl group polymers including: starches, polyvinyl alcohols and cellulose derivatives such as methylcellulose, ethylcellulose, hydroxyethylcellulose and carboxymethylcellulose and oxyethylene group polymers including: polyethylene glycol and/or ethylene oxide adducts of acids, amines, phenols, alcohols etc. Examples of these soil release polymers are commercially available from suppliers such as Clariant (DA-45C), Rhodia (Repeletex PF-594), and 3M (FC-258).

The cubic or layered (platelet) particles can be combined with two known fluorochemical classes of compounds, ones known for producing water and oil repellency on textile mill treatments and ones known for use as soil release agents on textile mill treatments. The fluorochemicals preferable have a melting point (as determined by DSC) between 25 and 100° C.

Some preferred fluorochemicals include, but are not limited to fluorinated acrylates, urethanes, or dendrimers that are typical to the textile finishing industry (repel). Also fluorinated versions of textile chemistry agents of the type that are considered hybrid dual function fluoropolymers or C4 type polymers (3M) (release).

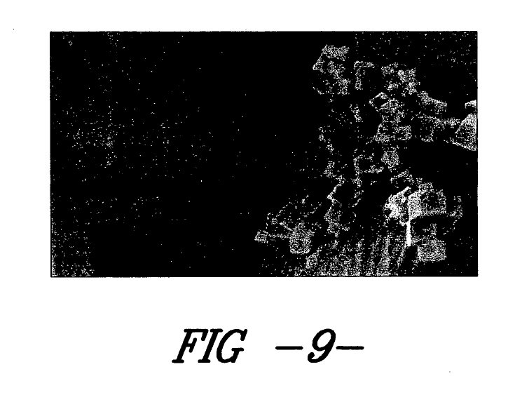

An antimicrobial agent may also be exhausted onto fabric via the rinse cycle and a fabric conditioning treatment. AlphaSan®, a known antimicrobial agent, is also a cubic crystal containing silver which can be added to the fabric conditioner. FIGS. 7-9 show images of the fabric with AlphaSan® on the fabric at 8,500×, 10,000×, and 10,000× respectively.

Preferably, the textile surface modification composition is added as a fabric conditioner would be during a wash cycle. The laundry would be loaded into a laundry machine and detergent would be added. The rinse additive is then applied during the rinse cycle of the wash. Various methods such as direct application, through a ball (fabric softener ball that releases its contents during the rinse cycle), or through the machine can be employed. Then the water would be removed from the fabric. This can be accomplished by air drying, machine drying, or ironing the fabric. Preferably, the laundered materials are then dried in a standard consumer tumble dryer or other processes that add heat. The treatment is non-durable and can be renewed in successive laundering cycles.

The addition of the cubic or layered (platelet) particles to the fabric rinse additive eliminates the need for padding on or pre-treating the fabric. Additionally, there is no curing step or cross-linking agent needed in the process to achieve the soil release characteristics.

Test Methods

### Stain Application

Samples were tested according to the Oily Stain Release Method AATCC 130-2000 with the variation that the samples were visually assessed and given a ranking of 1 to 5 (1 being the worst and 5 being the best) with 0.5 increments. A description of the staining and washing methods following AATCC 130-2000 is as follows:

For oily stains, a flat surface was covered with aluminum foil and 2 layers of “Scott” paper towels (one-ply sheets #01482). Next, using small droplet bottles, 5 drops of oil were dropped in the same location, and then covered with wax paper and a 5 lb weight for 1 minute. The samples were then hung to dry. The oils used were Mazola Corn Oil(# MZ-05820-LF-04), Finnast Mineral Oil Heavy (# NDC 49580-0600-1), and Burned Motor Oil (BMO).

For food stains a flat surface was covered with aluminum foil and 2 layers of “Scott” paper towels (one-ply sheets #01482). Next, a 1.25 inches (approx. 3.2 cm) diameter stain was applied using the back of a regular plastic pipette. The samples were then hung to dry. The foods used were Kraft Mustard (# 014-5602-022) and Hunt's Ketchup(#38184-BFA 60325).

For the synthetic dirt stains, a flat surface was covered with aluminum foil and 2 layers of “Scott” paper towels (one-ply sheets #01482). Next, a 1:2, dirt to water mixture was rubbed onto the fabric with a gloved finger to obtain a stain equal to 1.25 inches diameter. The samples were then hung to dry. The dirt used was AATCC Synthetic Carpet Soil (TM-122) from Textile Innovators.

The fabric size used in each test was between 11 by 7 (27.9 by 17.8 cm) inches to 11 by 13 inches (27.9 by 33.0 cm). The fabric used were from 100% cotton Hanes t-shirts that were each pre-washed with Tide liquid detergent.

### Washing Procedure

All washing was done in a standard consumer washer machine on the large load setting. The machine used 20-22 gallons water (76L-83L), 4 lb fabrics (1.82 Kg fabrics), 128 g Tide liquid detergent, and 46 g Downy fabric softener. The washing temperature was set at warm, 105° F. ±5° F. (40° C. ±3° C.) and the rinse temperature was set at cold, 77° F. (20-25° C.). The washing time included approximately 20 minutes of washing and spin cycles and 20 minutes of rinse and spin cycles.

The samples were dried in a standard consumer dryer at the high temperature (cotton high, 180° F. or 82° C.) setting for 40 minutes. All t-shirts (samples) were pre-washed with Tide detergent (4 lb large loading) and rinsed with water and no fabric softener before using for the examples.

### Transport Test Procedure

Treated and dried fabric (5×5 inches) were placed over a 180 ml beaker and fixed tightly with a rubber band. 5 drops of deionized water were placed in five separate locations on the fabric. Time was measured in seconds until a zero contact angle was obtained. The total average and standard deviation in seconds were reported.

The following examples illustrate the practice of this invention. They are not intended to be exhaustive of all possible variations of the invention. Parts and percentages are by weight unless otherwise indicated. All percentages are by weight unless otherwise specified.

### EXAMPLES

### Zeta Potential Measurements

The following are measurements of the zeta potential of Zeolite A (Na-A) dispersed in water, wash water with detergent, fabric conditioner and rinse water with fabric conditioner. As can be seen, the presence of the fabric conditioner converts the negative zeta potential of Zeolite A (Na-A) to a posive zeta. potential. Conversely, in the absence of fabric conditioner the zeta potential of Zeolite A (Na-A) remains negative

| | | Specific |
|---|---|---|
| | | Conductance |
| | | at 25° C. |
| Solution | Zeta Potential (mV) | (microSiemens/cm) |
| Zeolite A (Na-A) | −33.2 ± 2.5 | 40.0 |
| dispersed in water | | |
| Zeolite A (Na-A) | −55.3 ± 3.8 | 663.8 |
| dispersed in wash water | | |
| with detergent | | |
| Zeolite A (Na-A) | 81.7 ± 7.1 | 99.0 |
| dispersed in fabric | | |
| conditioner | | |
| Zeolite A (Na-A) | 7.61 ± 1.19 | 148.7 |
| dispersed in rinse water | | |
| with fabric conditioner | | |

### Effect of Particle Types on Stain Release

The following examples Control 1, Invention 1-5, and Comparison 1-4 show the effect particle type and concentration on soil release. The compositions of each example are found in Chart 1.

CHART 1
Particle Type of Example and Comparisons

| | | Manufacturer of |
|---|---|---|
| | Particle Type | Particles |
| Control 1 | Downy | Proctor and Gamble |
| | | (Downy) |
| Invention 1 | 0.5% Zeolite A (Na-A) in Downy | Valfor 100 from PQ |
| | | Corporation |
| Invention 2 | 2.0% Zeolite A (Na-A) in Downy | Valfor 100 from PQ |
| | | Corporation |
| Invention 3 | 0.5% Na-Y Zeolite in Downy | Grace Davison |
| Invention 4 | 0.5% Beta Zeolite in Downy | Grace Davison |
| Invention 5 | 1.0% Alumina C in Downy | Degussa |
| Comparison 1 | 0.5% Montmorillonite in Downy | Milliken |
| Comparison 2 | 0.5% Zinc Oxide in Downy | Alfa Aesar |
| Comparison 3 | 2% Alumina Phosphate in Downy | Aldrich |
| Comparison 4 | 2% Na Polyphosphate in Downy | Aldrich |

CHART 2
Food, Oil and Dirt Stain Release Evaluation

| | | | | Food/ | | | | Oil | All |
|---|---|---|---|---|---|---|---|---|---|
| | Ketch- | Mus- | Syn | Dirt | Miner- | Corn | | Stain | Stain |
| | up | tard | Dirt | Total | al Oil | Oil | BMO | Total | Total |
| Cont. 1 | 3 | 1 | 5 | 9 | 2 | 3 | 1.5 | 6.5 | 15.5 |
| Inv. 1 | 4.5 | 1.5 | 5 | 11 | 4 | 3 | 1.5 | 8.5 | 19.5 |
| Inv. 2 | 3.5 | 2 | 4 | 9.5 | 4 | 4.5 | 2.5 | 11 | 20.5 |
| Inv. 3 | 4 | 1.5 | 5 | 10.5 | 3 | 3 | 1.5 | 7.5 | 18 |
| Inv. 4 | 4.5 | 1.5 | 5 | 11 | 2 | 3 | 2 | 7 | 18 |
| Inv. 5 | 4 | 1.5 | 4 | 9.5 | 4 | 3.5 | 2 | 9.5 | 19 |
| Comp. 1 | 3 | 1.5 | 5 | 9.5 | 1 | 2 | 1 | 4 | 13.5 |
| Comp. 2 | 2 | 1 | 4.5 | 7.5 | 2 | 3 | 1 | 6 | 13.5 |
| Comp. 3 | 3 | 1 | 3.5 | 7.5 | 2.5 | 3 | 1.5 | 7 | 14.5 |
| Comp. 4 | 2.5 | 1 | 3.5 | 7 | 3 | 3 | 2 | 8 | 15 |

As can be seen in the stain evaluation numbers in Chart 2, the invention examples were superior in stain release. For the food and oil total (all of the individual stain numbers added together), the control had a score of 15.5 and the comparison examples had scores of between 13.5 and 15. The invention examples had score of between 18 and 20.5, a significant difference in stain release.

CHART 3
Zeta potential and Feeling on fabric evaluation

| | | Feeling on |
|---|---|---|
| | Zeta Potential | Fabric |
| Control 1 | n/a | |
| Invention 1 | Negative | soft |
| Invention 2 | Negative | soft |
| Invention 3 | Negative | soft |
| Invention 4 | Negative | soft |
| Invention 5 | Negative | dry |
| Comparison 1 | Negative | soft |
| Comparison 2 | | soft |
| Comparison 3 | | soft |
| Comparison 4 | | dry |

Chart 3 shows the zeta potential of the particles and the resulting feel of the fabric after it had been washed. Having a soft feel is preferable over a dry feel.

### Effect of Placing Particles and/or Fluorochemicals in Wash and Rinse Cycle

CHART 4
Compositions of Samples

| | Composition | Added |
|---|---|---|
| Control 1 | 100% Downy | In rinse cycle |
| Control 2 | 100% Tide | In wash cycle |
| Inv. 6 | 0.5% Zeolite A (Na-A) in Downy | In rinse cycle |
| Comp. 5 | 40 g Zeolite A (Na-A) with 98 g Tide | In wash cycle |
| Comp. 6 | 40 g Zeolite A (Na-A) with 98 g of | In wash cycle |
| | Tide and 10 g Rucoguard | |
| Comp. 7 | 40 g Zeolite A with 98 g of Tide | In wash cycle |
| | and 10 g of Synguard | |

For the samples in Chart 4, the Tide™ was commercially available Tide Clean Breeze™ and the Downy™ used was commercially available Downy Ultra Mountain Spring™, both obtained from Proctor and Gamble. The Zeolite A (Na-A) was obtained as Valfor 100 from PQ Corporation. Rucogaurd was obtained from Rudolf-Venture Chemicals and Synguard 105S was obtained from Milliken.

CHART 5
Stain release evaluation

| | | | | Food | | | | Oil | |
|---|---|---|---|---|---|---|---|---|---|
| | Ketch- | Mus- | Syn. | Stain | Min. | Corn | | Stain | Stain |
| | up | tard | Dirt | Total | Oil | Oil | BMO | Total | Total |
| Cont. 1 | 3 | 1 | 5 | 9 | 2 | 3 | 1.5 | 6.5 | 15.5 |
| Cont. 2 | 3.5 | 3.5 | 1.5 | 8.5 | 2 | 2 | 1 | 5 | 13.5 |
| Inv. 6 | 4.5 | 1.5 | 5 | 11 | 4 | 3 | 1.5 | 8.5 | 19.5 |
| Comp. 5 | 4.5 | 3 | 2 | 9.5 | 1 | 3.5 | 1 | 5.5 | 15 |
| Comp. 6 | 3.5 | 3.5 | 2 | 9 | 3.5 | 1.5 | 1.5 | 6.5 | 15.5 |
| Comp. 7 | 3.5 | 3.5 | 1.5 | 8.5 | 2.5 | 1.5 | 1 | 5 | 13.5 |

As one can see from Chart 5, adding zeolite (Comparison 5) and zeolite with fluorochemicals (Comparisons 6 and 7) in the wash cycle of the laundering with Tide did not significantly improve the stain release characteristics of the test fabric compared to just using Tide (Control 2). Surprisingly, when the zeolite was added with Downy in the rinse cycle (Invention 6), there was a significant, unexpected improvement in stain release in both food type stains and oil type stains compared to just Downy in the rinse cycle (Control 1) and adding zeolite to the wash cycle with Tide (Comparisons 5-7).

CHART 6
Compositions, Average Particle Size and
Stability in Solution of Examples

| | Effect of Particle Size | | |
|---|---|---|---|
| | | Avg. Particle | Stability in |
| | Composition | Size of Zeolite | Solution |
| Inv. 7 | 46 g Downy + 22.5 g | 0.75 micrometers | Stable after |
| | Zeolite A (Na-A) at | | 1 week |
| | 40% solids in water | | |
| Comp. 8 | 46 g Downy + 22.5 g | 4.33 micrometers | Settled out of |
| | Zeolite A (Na-A) at | | solution in less |
| | 40% solids in water | | than 24 hours |

CHART 7
Stain release evaluation

| | | | | Food | | | | Oil | |
|---|---|---|---|---|---|---|---|---|---|
| | Ketch- | Mus- | Syn. | Stain | Min. | Corn | | Stain | Stain |
| | up | tard | Dirt | Total | Oil | Oil | BMO | Total | Total |
| Inv. 7 | 3.5 | 1.5 | 3 | 8 | 3 | 3.5 | 2.5 | 9 | 17 |
| Comp. 8 | 4 | 1 | 5 | 10 | 2.5 | 3 | 2.5 | 8 | 18 |

As can be seen in Chart 7, there is not a significant stain release performance advantage to having a smaller particle size of zeolite. However, there is a significant stability in solution advantage to the smaller sized zeolite particles of Invention 7 compared to Comparison 8. Stability is critical to a product like a fabric conditioner that will sit for long periods of time before use on a store shelf and at a consumer's home.

CHART 8
Compositions
Effect of Fluorochemicals

| | Rinse Treatment Formulations |
|---|---|
| Control 1a | 46 g Downy |
| Control 1b | 46 g Downy |
| Control 1c | 46 g Downy |
| Invention 8a | 42 g Downy + 4 g SS-E |
| Invention 8b | 42 g Downy + 4 g SS-E |
| Invention 8c | 42 g Downy + 4 g SS-E |
| Invention 9a | 46 g Downy + 9 g Zeolite A |
| Invention 9b | 46 g Downy + 9 g Zeolite A |
| Invention 9c | 46 g Downy + 9 g Zeolite A |
| Invention 10a | 44 g Downy + 9 g Zeolite A + 4 g SS-E |
| Invention 10b | 44 g Downy + 9 g Zeolite A + 4 g SS-E |
| Invention 10c | 44 g Downy + 9 g Zeolite A + 4 g SS-E |

SS-E is a composition comprising fluorochemicals and is 33.3% Zonyl 7713 and 66.6% TG-992 which is a fluorochemical. Zonyl was obtained from DuPont and TG-992 was obtained from Daiken.

Each sample was tested three times, the sample was first run though the washing cycle and had a treatment applied, then was stained and washed again to test stain release and these results are labeled “a”. This process was repeated an additional two times, labeled “b” and “c”.

CHART 9
Stain release evaluation

| | | | | Food | | | | Oil | |
|---|---|---|---|---|---|---|---|---|---|
| | Ketch- | Mus- | Syn. | Stain | Min. | Corn | | Stain | Stain |
| | up | tard | Dirt | Total | Oil | Oil | BMO | Total | Total |
| Cont. 1a | 3.5 | 1.5 | 2 | 7 | 5 | 4 | 2 | 11 | 18 |
| Cont. 1b | 2 | 1 | 3.5 | 6.5 | 5 | 3 | 2 | 10 | 16.5 |
| Cont. 1c | 2 | 1 | 2.5 | 5.5 | 4.5 | 3 | 2 | 9.5 | 15 |
| Inv. 8a | 4.5 | 1 | 4.5 | 10 | 2.5 | 4 | 2 | 8.5 | 18.5 |
| Inv. 8b | 4 | 1.5 | 4.5 | 10 | 3 | 4 | 3 | 10 | 20 |
| Inv. 8c | 3.5 | 1.5 | 4 | 9 | 2.5 | 4.5 | 3 | 10 | 19 |
| Inv. 9a | 4 | 1 | 5 | 10 | 2.5 | 3 | 2.5 | 8 | 18 |
| Inv. 9b | 4 | 1.5 | 5 | 10.5 | 2.5 | 3 | 2.5 | 8 | 18.5 |
| Inv. 9c | 3.5 | 1 | 5 | 9.5 | 2.5 | 3 | 2 | 7.5 | 17 |
| Inv. 10a | 4.5 | 1 | 3.5 | 9 | 3 | 4.5 | 2.5 | 10 | 19 |
| Inv. 10b | 4.5 | 1.5 | 4.5 | 10.5 | 3.5 | 4.5 | 3 | 11 | 21.5 |
| Inv. 10c | 4.5 | 1.5 | 4 | 10 | 2 | 4 | 3 | 9 | 19 |

As can be seen in Chart 9, the addition of both the fluorochemicals (SS-E) and zeolite independently serve to increase the stain release performance compared to Downy alone. The combination of fluorochemicals and zeolites further improves the stain release performance versus the performance of either independently. It should also be noted that the addition of Downy in successive laundry cycles increases the staining of the fabric. The addition of both the fluorochemical and zeolite helps to diminish this trend.

CHART 10
Seconds until sample reaches a contact angle of 0 degrees

| | Average (sec) | St.dev |
|---|---|---|
| Control | 2.6 | 0.89 |
| Invention 10b | 25.4 | 14.70 |
| Invention 10c | 36.6 | 11.70 |
| Invention 1 | 0 | 0 |

Chart 10 shows that when fluorochemicals are added into the rinse cycle of laundering, the resultant fabric has repellency to water. The control is the repellency that is seen when just Downy is added to the rinse cycle. Fabric conditioner is required for repel at this level.

As can been seen from all of the examples above, the addition of a zeolite, alumina, or silica with a negative zeta potential, when added with a fabric softener in the rinse cycle of laundering, produces unexpected stain release as well as other desirable characteristics. Fabric softener as it is added over successive launderings increases the stain retention on the fabric. The addition of these particles also helps to minimize the stain retention over successive launderings that fabric conditioner causes.

The invention has been described in detail with particular reference to certain preferred embodiments thereof, but it will be understood that variations and modifications can be affected within the spirit and scope of the invention.

What is claimed is:

1. A textile surface modification composition comprising a fabric conditioner and cubic or layered platelet particles having a negative zeta potential, wherein the cubic or layered platelet particles are selected from the group consisting of zeolites, aluminas, and silicas.

2. The textile surface modification composition of claim 1, wherein the cubic or layered platelet particles comprise zeolites.

3. The textile surface modification composition of claim 1, wherein the cubic or layered platelet particles have a particle size of between 0.1 and 25 micrometers.

4. The textile surface modification composition of claim 1, wherein the cubic or layered platelet particles have a particle size between 0.1 and 15 micrometers.

5. The textile surface modification composition of claim 4, wherein the cubic or layered platelet particles have a particle size between 0.2 and 10 micrometers.

6. The textile surface modification composition of claim 5, wherein the cubic or layered platelet particles have a particle size between 3 and 10 micrometers.

7. The textile surface modification composition of claim 1, wherein the textile surface modification composition further comprises a soil release polymer selected from the group consisting of carboxyl group polymers, hydroxyl group polymers and oxyethylene group polymers.

8. The textile surface modification composition of claim 1, wherein the textile surface modification composition further comprises a fluorochemical.

9. The textile surface modification composition of claim 8, wherein the fluorochemical is selected from the group consisting of fluorinated acrylates, urethanes, and dendrimers.

10. The textile surface modification composition of claim 1, wherein the cubic or layered platelet particles are between 5 and 80 percent by weight of the textile surface modification composition.

11. The textile surface modification composition of claim 1, wherein the cubic or layered platelet particles are between 1 and 80 percent by weight of the textile surface modification composition.

12. The textile surface modification composition of claim 1, wherein the cubic or layered platelet particles are between 10 and 40 percent by weight of the textile surface modification composition.

13. The textile surface modification composition of claim 1, further comprising an antimicrobial agent.

14. The process of applying a textile surface modification composition comprising:
washing fabric with a detergent and water;
adding the textile surface modification composition of claim 1 to a rinse cycle; and,
removing the water from the fabric.

15. The process of claim 14, wherein the textile surface modification composition is added in an amount such that the cubic or layered platelet particles are between 0.25 and 4% by weight of the fabric.

16. The process of claim 14, wherein the textile surface modification composition is added in an amount such that the cubic or layered platelet particles are between 0.012 and 4% by weight of the fabric.

17. The process of claim 14, wherein the textile surface modification composition is added in an amount such that the cubic or layered platelet particles are between 0.5 and 2% by weight of the fabric.

18. The process of claim 14, wherein an antimicrobial agent is added during the rinse cycle.

19. The process of claim 14, wherein the textile surface modification composition produces tactile modification of the treated fabric.

20. A fabric treated with the textile surface modification composition of claim 1.
